(19) United States
(12) Patent Application Publication
(10) Pub. No.: US 2009/0108093 A1
(43) Pub. Date: Apr. 30, 2009

(54) FUEL INJECTOR

(76) Inventors: Patrick Mattes, Stuttgart (DE); Michael Mennicken, Wimsheim (DE); Hans-Christoph Magel, Reutlingen (DE); Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/294,266

(22) PCT Filed: Feb. 16, 2007
(86) PCT No.: PCT/EP2007/051487

§ 371 Date: Sep. 24, 2008

(30) Foreign Application Priority Data
Apr. 4, 2006 (DE) 102006015744.3
Jan. 18, 2007 (DE) 102007002758.5

(51) Int. Cl. F02M 47/02; F02M 51/06

(52) U.S. Cl. 239/96; 239/585.5

(57) ABSTRACT

The invention relates to a fuel injector having an injector housing which has a high-pressure fuel connection which is connected outside the injector housing to a central high-pressure fuel source and inside the injector housing to a pressure space. From the fuel injector highly pressurized fuel is injected into a combustion chamber of an internal combustion engine as a function of the pressure in a control space when a nozzle needle opens In order to provide a fuel injector which can be manufactured inexpensively, the pressure in the control space is controlled directly by a magnetic actuator.

The invention relates to a fuel injector as recited in the preamble to claim 1.

### PRIOR ART

It is known to use stroke-controlled fuel injectors to deliver fuel into direct-injecting diesel engines. This has the advantage that it is possible to adjust the injection pressure to the load and engine speed. The triggering of injectors by means of a piezoelectric actuator can occur directly or with the interposition of a servo-control chamber.

### DISCLOSURE OF THE INVENTION

The object of the invention is to create a fuel injector as recited in the preamble to claim 1 that is inexpensive to manufacture.

In a fuel injector with an injector housing that has a high-pressure fuel connection communicating with a central high-pressure fuel source on the outside and communicating with a pressure chamber inside the injector housing, from which pressure chamber highly pressurized fuel is injected into a combustion chamber of an internal combustion engine when a nozzle needle opens as a function of the pressure in a control chambers the object of the invention is attained in that the pressure in the control chamber is controlled directly by means of a solenoid actuator. The solenoid actuator has the advantage that it represents a rugged, known technology and even when operated at high pressure, has a long service life and low manufacturing costs.

A preferred exemplary embodiment of the fuel injector is characterized in that the solenoid actuator includes a coil that cooperates with an armature, which, when the coil is activated, executes an armature stroke induced by means of a magnetic force. The coil is molded in epoxy resin, for example, in order to seal it off from the fuel.

Another preferred exemplary embodiment of the fuel injector is characterized in that the armature is coupled to the nozzle needle via a hydraulic coupler that reduces the armature stroke and intensifies the magnetic force. Because of a high system pressure of up to 2000 bar, very high switching forces can be required to open the nozzle needle. These forces can be implemented through the intensification of the magnetic force. Preferably, a high force intensification of approximately 4 to 10 is used. With the force range of the solenoid actuator of approximately 40 to 100 Newton, it is therefore possible to produce the required nozzle opening force of approximately 250 to 500 Newton. At the same time, the hydraulic coupler reduces the armature stroke to a desired dimension.

Another preferred exemplary embodiment of the fuel injector is characterized in that the hydraulic coupler has a coupler piston, which is mechanically coupled to the armature and whose end oriented toward the combustion chamber delimits the control chamber. This achieves a simple mechanical construction that minimizes complexity from a production engineering standpoint. The coupler piston represents a first booster piston. A solenoid plunger can be integrated into the coupler piston.

Another preferred exemplary embodiment of the fuel injector is characterized in that the control chamber is delimited by the end of the nozzle needle oriented away from the combustion chamber. The nozzle needle represents a second booster piston. The control chamber, which is also referred to as the coupler chamber, is situated in the axial direction between the end of the nozzle needle oriented away from the combustion chamber and the end of the coupler piston oriented toward the combustion chamber. The coupler chamber hydraulically couples the nozzle needle to the coupler piston.

Another preferred exemplary embodiment of the fuel injector is characterized in that the end of the coupler piston oriented toward the combustion chamber has a smaller diameter than the end of the nozzle needle oriented away from the combustion chamber. In a simple fashion, this achieves an intensification of the magnetic force and a reduction of the armature stroke.

Another preferred exemplary embodiment of the fuel injector is characterized in that the hydraulic coupler has a coupler piston, which is mechanically coupled to the armature and whose end oriented toward the combustion chamber delimits a partial control chamber remote from the combustion chamber. The pressure in the partial control chamber remote from the combustion chamber can be selectively changed, in particular reduced, through a movement of the coupler piston.

Another preferred exemplary embodiment of the fuel injector is characterized in that the partial control chamber remote from the combustion chamber is delimited by a spring-prestressed sleeve, which is guided on the end of the coupler piston oriented toward the combustion chamber and rests with a biting edge against a throttle plate. The spring prestressing force is sufficiently low and preferably amounts to between 10 and 20 Newton.

Another preferred exemplary embodiment of the fuel injector is characterized in that the throttle plate has a through hole that connects the partial control chamber remote from the combustion chamber to a partial control chamber, which is close to the combustion chamber and is delimited by the end of the nozzle needle oriented away from the combustion chamber. The through hole transmits a pressure decrease from the partial control chamber remote from the combustion chamber to the partial control chamber close to the combustion chamber.

Another preferred exemplary embodiment of the fuel injector is characterized in that the end of the coupler piston oriented toward the combustion chamber has a larger diameter than the end of the nozzle needle oriented away from the combustion chamber. The end of the coupler piston oriented toward the combustion chamber preferably has a diameter of approximately 8 mm. The end of the nozzle needle oriented away from the combustion chamber preferably has a diameter of approximately 3.5 mm. With an armature stroke of 30 μm, it is thus possible to produce a needle stroke of approximately 180 μm.

Another preferred exemplary embodiment of the fuel injector is characterized in that the end of the coupler piston oriented away from the combustion chamber delimits a compensation volume that communicates with a storage volume containing the end of the coupler piston oriented toward the combustion chamber. As a result, the control piston is completely pressure balanced.

Another preferred exemplary embodiment of the fuel injector is characterized in that the coupler piston is guided by means of a coupler piston-guiding section that connects the storage volume to a solenoid actuator accommodating chamber that accommodates the solenoid actuator. The diameter of the coupler piston-guiding section is selected so as to minimize the leakage from the storage volume into the solenoid actuator accommodating chamber.

Another preferred exemplary embodiment of the fuel injector is characterized in that the solenoid actuator accommodating chamber communicates with a pressure relief chamber. The leakage occurring in the coupler piston-guiding section is conveyed into the pressure relief chamber.

The fuel injector described in the preceding paragraphs enables a multiple injection with a simultaneously optimized overall hydraulic efficiency. According to an essential aspect of the invention, the fuel injector includes an integrated damping volume or storage volume. In addition, the fuel injector according to the invention makes it possible to avoid leakage losses and control quantities. This achieves an inexpensive-to-manufacture, directly switching fuel injector with a solenoid actuator. Integrating the solenoid actuator into a holding element of the injector housing makes it possible to reduce the structural length of the fuel injector.

The associated function principle permits an optimization of the overall hydraulic efficiency, which makes it possible to use smaller high-pressure pumps. Since the number of injections and control quantities no longer figures into the overall quantity balance of the system, it is possible to achieve higher degrees of freedom in terms of applicability.

Through the avoidance of a hydraulic reaction (diversion surge) on the solenoid actuator, it is possible to improve the performance of the injector. In particular, the elimination of a rail and a pressure control valve makes it possible to create an inexpensive system in which the pressure decrease is achieved by means of an intentional leakage.

Another preferred exemplary embodiment of the fuel injector is characterized in that the control chamber is delimited by a control chamber-delimiting sleeve that is guided in a sealed fashion on the end of the nozzle needle oriented away from the combustion chamber. The control chamber, which is also referred to as the coupling chamber, can also include several partial coupling chambers that communicate with one another. Through the use of a throttle between the partial coupling chambers, it is possible to further optimize the opening characteristic curve of the nozzle needle. Through a damping of the opening speed, it is thus possible to achieve an optimized micro-quantity capacity and an advantageous injection rate curve.

Another preferred exemplary embodiment of the fuel injector is characterized in that the solenoid actuator is situated in an actuator chamber that is acted on by highly pressurized fuel. The actuator chamber simultaneously serves as a damping and storage volume.

Another preferred exemplary embodiment of the fuel injector is characterized in that the armature chamber communicates with the control chamber. The connection can be implemented by means of corresponding coupler gaps that are provided, for example, between the coupler piston and the injector housing.

Another preferred exemplary embodiment of the fuel injector is characterized in that the nozzle needle has a double seat. In this instance, the nozzle needle has a number of flow conduits that enable a central fuel supply to the needle tip. The injection ports are preferably sealed by means of two sealing seats of the nozzle needle. When the nozzle needle opens, the two sealing seats are opened simultaneously and they can have a relatively large diameter without generating high needle forces. This achieves a dethrottling of the nozzle at a slight nozzle needle stroke, for example of 50 μm.

### BRIEF DESCRIPTION OF THE DRAWINGS

FIG. 1 shows a simplified longitudinal section through a fuel injector according to the invention and

FIG. 2 shows a longitudinal section through a fuel injector according to a second exemplary embodiment.

### EMBODIMENTS OF THE INVENTION

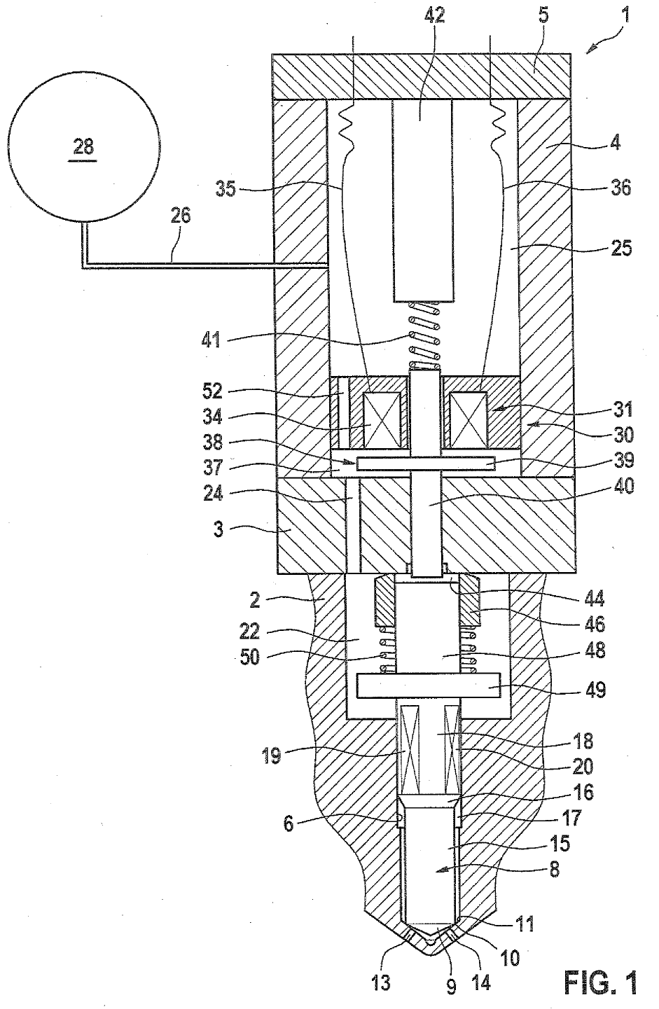

FIG. 1 shows a longitudinal section through a fuel injector with an injector housing 1. The injector housing 1 includes a nozzle body 2 whose freely extending lower end protrudes into a combustion chamber of an internal combustion engine to be supplied with fuel. A retaining nut (not shown) clamps the upper end surface of the nozzle body 2 oriented away from the combustion chamber axially against an intermediate element 3 and an injector body 4. The injector body 4 is essentially embodied in the form of a circular cylindrical sheath-shaped sleeve whose one end surface is sealed by the intermediate element 3 and whose other end surface is sealed by an injector head 5.

The nozzle body 2 has an axial guide bore 6 let into it, in which a nozzle needle 8 is guided in an axially sliding fashion. At the tip 9 of the nozzle needle 8, a sealing edge 10 is provided, which cooperates with a sealing seat or sealing surface 11 in order to selectively open or close two injection ports 13 and 14 depending on the position of the nozzle needle 8. When the sealing edge 10 of the nozzle needle tip 9 lifts away from its sealing seat, then highly pressurized fuel is injected through the injection ports 13 and 14 into the combustion chamber of the internal combustion engine.

Starting from the tip 9, the nozzle needle 8 has a pressure chamber section 15, which is followed by a section 16 that widens out in the fashion of a truncated cone, which is also referred to as the pressure shoulder. The pressure shoulder is situated in a pressure chamber 17 embodied between the nozzle needle 8 and the nozzle body 2. The pressure shoulder 16 is followed by a guiding section 18, which is guided so that it is able to move back and forth in the guide bore 6. Flattened regions 19, 20 on the guiding section 18 produce a fluid connection between the pressure chamber 17 and a nozzle spring chamber 22.

By means of a connecting conduit 24 that is provided in the intermediate element 3, the nozzle spring chamber 22 communicates with an actuator chamber 25 that is in turn connected via a supply conduit or a supply line 26 to a high-pressure fuel source 28 that is also referred to as a common rail. A solenoid actuator 30 is situated in the actuator chamber 25, which is acted on with high pressure.

The solenoid actuator 30 includes an electromagnet 31 that is attached to the injector body 4. The electromagnet 31 contains a magnet coil 34 that is connected to a power supply via lines 35, 36. The magnet coil 35 cooperates with an armature 38 that is situated so that it is able to move axially in an armature chamber 37. The armature 38 is embodied in the form of a circular washer 39 that is fastened to a coupler piston 40.

At its end oriented away from the combustion chamber, the coupler piston 40 is acted on by a prestressed actuator spring 41 that is clamped between the coupler piston 40 and a support mandrel 42 that extends from the injector head 5. The end of the coupler piston 40 oriented toward the combustion chamber protrudes into a coupler chamber 44, which is also referred to as the control chamber. The coupler chamber 44 is delimited in the radial direction by a control chamber-delimiting sleeve 46, which is guided in a sealed fashion on an end section 48 of the nozzle needle 8 oriented away from the combustion chamber. A collar 49 protrudes radially outward between the end section 48 and the guiding section 18 of the nozzle needle 8. A nozzle spring 50 is clamped between the collar 49 and the control chamber-delimiting sleeve 46 in the nozzle spring chamber 22.

The nozzle spring chamber 22 communicates with the pressure chamber 17 via the flattened regions 19 and 20 and communicates with the armature chamber 37 the via the high-pressure connecting conduit 24. Via an additional high-pressure connecting conduit 52, the armature chamber 37 in turn communicates with the armature chamber 25, which is filled with highly pressurized fuel via the fuel supply line 25.

The actuator spring 41 prestresses the coupler piston 40 into its neutral position. In the neutral position of the fuel injector, high pressure prevails in the coupler chamber 44, which is also referred to as the rail pressure. The nozzle needle 8 is closed. In the neutral position, the solenoid actuator 30 is not supplied with current. In order to trigger the injector, the solenoid actuator 30 is supplied with current and therefore pulls the coupler piston 40 upward, i.e. toward the injector head 5. As a result, the pressure in the coupler chamber 44 decreases and the nozzle needle 8 opens.

Since the diameter of the coupler piston 40 is smaller than the diameter of the nozzle needle 8 in the end section 48, the nozzle needle 8 is acted on by a force that is intensified in comparison to the magnetic force exerted by the solenoid actuator 30. In order to close the nozzle needle 8, the supply of current is terminated. Then the prestressed compression spring 41 pushes the coupler piston 40 downward again, i.e. toward the combustion chamber, and the nozzle needle 8 closes. The electrical contacting of the solenoid actuator 30 is embodied in a suitable high-pressure-tight way, for example by the lines 35, 36 being embedded in molten glass.

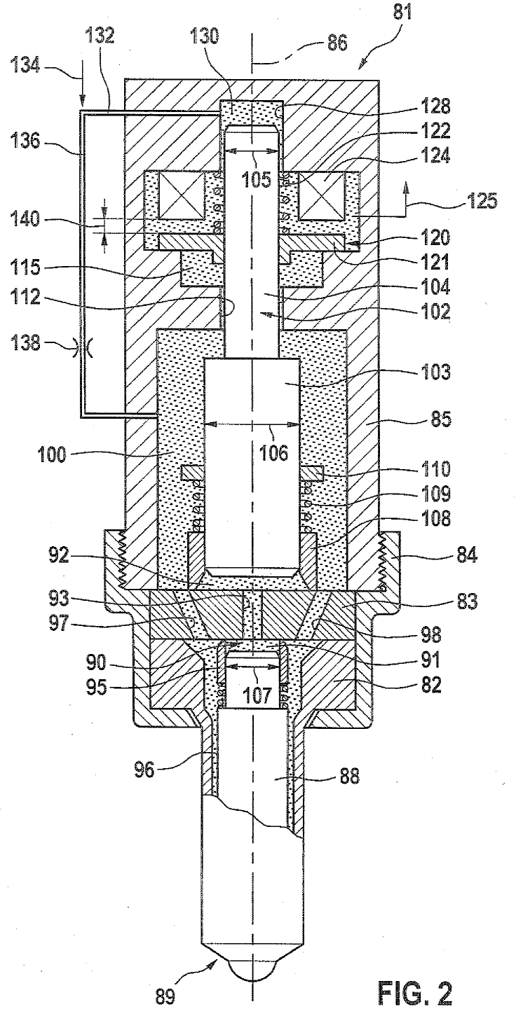

FIG. 2 shows a longitudinal section through a fuel injector with an injector housing 81. The injector housing 81 has a nozzle body 82 whose freely extending lower end 89 protrudes into a combustion chamber of an internal combustion engine. A retaining nut 84 clamps the upper end surface of the nozzle body 82 oriented away from the combustion chamber against a holding body 85, with the interposition of a throttle plate 83. A nozzle needle 88 is supported so that it can move back and forth in the nozzle body 82 and it opens and closes at least one injection opening at the end 89 of the nozzle body 82 as a function of the pressure in a control chamber.

The control chamber 90 includes a partial control chamber 91, which is close to the combustion chamber and is delimited in the axial direction by the throttle plate 83 and by the end of the nozzle needle 88 oriented away from the combustion chamber. In the radial direction, the partial control chamber 91 close to the combustion chamber is delimited by a spring-prestressed sleeve 95 that rests with a biting edge against the throttle plate in a sealed fashion. The partial control chamber 91 close to the combustion chamber communicates with a partial control chamber 92 remote from the combustion chamber via a through hole 93 extending through the throttle plate 83. The partial control chamber 92 remote from the combustion chamber is delimited in the axial direction, i.e. in the direction of a longitudinal axis 86 of the fuel injector, by the throttle plate 83 and by the end of a coupler piston 102 oriented toward the combustion chamber. In the radial direction, the partial control chamber 92 remote from the combustion chamber is delimited by a spring-prestressed sleeve 108 that rests with a biting edge against the throttle plate 83.

Really outside the through hole 93, the throttle plate 83 is equipped with connecting conduits 97, 98 that connect an annular chamber 96, which is provided in the nozzle body 82 radially outside the nozzle needle 88, to a storage volume 100 provided in the holding body 85 radially outside the coupler piston 102.

The coupler piston 102 has a coupler piston section 103 that is oriented toward the combustion chamber and has an outer diameter 106 of approximately 8 mm. The coupler piston section 103 oriented toward the combustion chamber is integrally joined to a coupler piston section 104 that is oriented away from the combustion chamber and has an outer diameter 105 of 3.5 mm. The sleeve 108 is guided on the end oriented toward the combustion chamber of the coupler piston section 103 oriented toward the combustion chamber. Analogously, the sleeve 95 is guided on the end of the nozzle needle 88 that is oriented away from the combustion chamber and has an outer diameter 107 of 3.5 mm. The outer diameter 107 of the end of the nozzle needle 88 oriented away from the combustion chamber is therefore equal to the outer diameter 105 of the coupler piston section oriented away from the combustion chamber 104. The sleeve 108 is prestressed by means of a helical compression spring 109 that is clamped between the sleeve 108 and a collar 110 that is attached to the coupler piston section 103 oriented toward the combustion chamber.

The coupler piston 102 is guided with its coupler piston section 104 oriented away from the combustion chamber in a through hole 112, which is provided in the holding body 85 and is also referred to as the coupler piston-guiding section. The through hole 112 connects the storage volume 100 to a solenoid actuator accommodating chamber 115. The solenoid actuator accommodating chamber 115 contains a solenoid actuator 120 that includes an armature 121 that is fastened to the coupler piston section 104 oriented away from the combustion chamber. A spring 122 prestresses the armature 104 in the direction toward the combustion chamber. The spring 122 is clamped between the armature 121 and the end of the holding body 85 oriented away from the combustion chamber. Radially outside the spring 122, the solenoid actuator accommodating chamber 115 inside the holding body 85 contains a magnet or a magnet coil 124. When the magnet coil 124 is supplied with current, the armature 121 is pulled toward the magnet coil 124. The associated armature stroke is labeled 140 and amounts to 30 μm.

An angled arrow 125 indicates that the solenoid actuator accommodating chamber 115 communicates with a pressure relief chamber. The connection 125 serves to drain off leakage occurring at the high-pressure passage at which the coupler piston section 104 oriented away from the combustion chamber extends through the through hole 112 between the highly pressurized storage volume 100 and the low-pressure solenoid actuator accommodating chamber 115.

The end oriented away from the combustion chamber of the coupler piston section 104 oriented away from the combustion chamber is guided in a blind hole 128 in the end of the holding body 85 oriented away from the combustion chamber and its end surface delimits a compensation volume 130. The compensation volume 130 communicates with a high-pressure fuel source indicated by an arrow 134 via a high-pressure connecting line 132. The high-pressure fuel source 134 and the high-pressure fuel line 132 communicate with the storage volume 100 via a high-pressure line 136 in which a throttle 138 is provided.

In comparison to a piezoelectric actuator, the solenoid actuator 120, which is also referred to as a solenoid actuating element, can only produce smaller forces on the order of magnitude of between 50 and 100 Newton. This is in contrast with the fact that the solenoid actuator 120 can implement larger actuation distances, which has an advantageous effect on the structural size of the fuel injector. The area ratio between the coupler piston section 103 oriented toward the combustion chamber and the end of the nozzle needle 88 oriented away from the combustion chamber is selected so that the solenoid actuator 120 is able to produce a needle stroke of 140 to 240 μm. Thus with an armature stroke 140 of 30 μm, the 3.5 mm/8 mm diameter step makes it possible to achieve a needle stroke of 180 μm.

The injection process is initiated by supplying current to the magnet coil 124. The pressure in the control chamber 90 is reduced in proportion to the stroke of the armature 121 so that the nozzle needle 88 lifts away from the seat after the pressure falls below the opening pressure As a unit, the coupler piston 102 is completely pressure-balanced. In order to assure a reliable closing, the closing process is carried out by the action of the spring 122 on the armature 121 after the magnet coil 124 is switched off. The prestressing force of the spring 122 is between 50 and 100 Newton, preferably between 70 and 90 Newton.

The throttle 138 in the high-pressure line 136 serves to reduce the high pressure in the storage volume 100 in comparison to the compensation volume 130. As a result, the sleeve 108 on the coupler piston section 103 oriented toward the combustion chamber can more easily lift off since the prestressing force of the spring 109 is sufficiently low.

The prestressing force of the spring 109 preferably lies between 10 and 20 Newton.

The solenoid actuator accommodating chamber 115 can be acted on by meals of low pressure as indicated by the angled arrow 125. The solenoid actuator accommodating chamber 115 can, however, also be acted on with high pressure. When installed in a low-pressure situation, a permanent leakage occurs at the high-pressure passages of the coupler piston section 104 oriented away from the combustion chamber in the holding body 85. Through a corresponding selection of the diameter at the high-pressure passages, i.e. the diameters of the through hole 112 and of the blind hole 128 in the holding body 85, it is possible to achieve a desired quantity balance in the overall system, particularly since the injector concept presented does not involve any control quantities. Furthermore, with a permanent leakage, there is the possibility of decreasing the pressure when the vehicle is coasting. With an integration of the solenoid actuator 120 in a high-pressure situation, under some circumstances, more complex seals must be used for the magnet coil 124 and the electrical contacting.

1-18. (canceled)

19. A fuel injector, comprising:
an injector housing;
a high-pressure fuel connection communicating with a high-pressure fuel source outside of the injector housing; and
a pressure chamber inside the injector housing communicating with the high-pressure fuel connection;
a control chamber disposed in the injector housing;
a nozzle needle disposed in the injector housing, which opens as a function of the pressure in the control chamber to inject highly pressurized fuel from the pressure chamber into a combustion chamber of an internal combustion engine; and
a solenoid actuator disposed in the injector housing, wherein the solenoid actuator directly controls the pressure in the control chamber.

20. The fuel injector as recited in claim 19, wherein the solenoid actuator includes a coil that cooperates with an armature which when the coil is activated the armature executes an armature stroke induced by means of a magnetic force.

21. The fuel injector as recited in claim 20, wherein the armature is coupled to the nozzle needle via a hydraulic coupler.

22. The fuel injector as recited in claim 21, wherein the hydraulic coupler reduces the armature stroke and intensifies the magnetic force.

23. The fuel injector as recited in claim 21, wherein the hydraulic coupler has a coupler piston, which is mechanically coupled to the armature and has an end oriented toward the combustion chamber that delimits the control chamber.

24. The fuel injector as recited in claim 22, wherein the hydraulic coupler has a coupler piston, which is mechanically coupled to the armature and has an end oriented toward the combustion chamber that delimits the control chamber.

25. The fuel injector as recited in claim 23, wherein the control chamber is delimited by an end of the nozzle needle oriented away from the combustion chamber.

26. The fuel injector as recited in claim 24, wherein the control chamber is delimited by an end of the nozzle needle oriented away from the combustion chamber.

27. The fuel injector as recited in claim 25, wherein the end of the coupler piston oriented toward the combustion chamber has a smaller diameter than the end of the nozzle needle oriented away from the combustion chamber.

28. The fuel injector as recited in claim 19, wherein the hydraulic coupler has a coupler piston, which is mechanically coupled to the armature and has an end oriented toward the combustion chamber that delimits a partial control chamber remote from the combustion chamber.

29. The fuel injector as recited in claim 28, wherein the partial control chamber remote from the combustion chamber is delimited by a spring-prestressed sleeve, which is guided on the end of the coupler piston oriented toward the combustion chamber and rests with a biting edge against a throttle plate.

30. The fuel injector as recited in claim 29, wherein the throttle plate has a through hole that connects the partial control chamber remote from the combustion chamber to a partial control chamber which is close to the combustion chamber and which is delimited by the end of the nozzle needle oriented away from the combustion chamber.

31. The fuel injector as recited in claim 28, wherein the end of the coupler piston oriented toward the combustion chamber has a larger diameter than an end of the nozzle needle oriented away from the combustion chamber.

32. The fuel injector as recited in claim 28, wherein an end of the coupler piston oriented away from the combustion chamber delimits a compensation volume that communicates with a storage volume containing the end of the coupler piston oriented toward the combustion chamber.

33. The fuel injector as recited in claim 32, wherein the coupler piston is guided by means of a coupler piston-guiding section that connects the storage volume to a solenoid actuator accommodating chamber that accommodates the solenoid actuator.

34. The fuel injector as recited in claim 33, wherein the solenoid actuator accommodating chamber communicates with a pressure relief chamber.

35. The fuel injector as recited in claim 30, wherein the control chamber or the partial control chamber close to the combustion chamber is delimited by a control chamber-delimiting sleeve that is guided in a sealed fashion on the end of the nozzle needle oriented away from the combustion chamber.

36. The fuel injector as recited in claim 19, wherein the solenoid actuator is situated in an actuator chamber that is acted on by highly pressurized fuel.

37. The fuel injector as recited in claim 19, wherein the armature chamber communicates with the control chamber.

38. The fuel injector as recited in claim 19, wherein the nozzle needle has a double seat.
